(19) United States
(12) Patent Application Publication
(10) Pub. No.: US 2015/0363036 A1
(43) Pub. Date: Dec. 17, 2015

(54) ELECTRONIC DEVICE, INFORMATION PROCESSING METHOD, AND INFORMATION PROCESSING PROGRAM

(71) Applicant: SHARP KABUSHIKI KAISHA, Osaka-shi, Osaka (JP)

(72) Inventor: Norio NASU, Osaka-shi (JP)

(21) Appl. No.: 14/655,391

(22) PCT Filed: Feb. 12, 2014
(86) PCT No.: PCT/JP2014/053226

§ 371 Date: Jun. 25, 2015

(30) Foreign Application Priority Data
Mar. 13, 2013 (JP) 2013-050785

(51) Int. Cl. G06F 3/041

(52) U.S. Cl. CPC G06F 3/0416

(57) ABSTRACT

An operation input unit accepts an operation input. An operation type determination unit determines an operation type, the determination being made in accordance with a distribution of regions in which the operation input is accepted in pre-established partial regions of the operation input unit. An operation control unit controls a processing according to the operation input, the control being made in response to the operation type determined by the operation type determination unit.

### TECHNICAL FIELD

The present invention relates to an electronic device, an information processing method, and an information processing program.

The subject application claims priority based on the patent application No. 2013-050785 filed in Japan on Mar. 13, 2013 and incorporates by reference herein the content thereof.

### BACKGROUND ART

Electronic devices such as multifunction mobile telephone handsets have a display panel to display an image and a touch panel that accepts operation inputs from a user touching the surface thereof (hereinafter referred to as a “touch panel display”).

This is an attempt to reduce the size and improve the ease of operation of an electronic device. In an electronic device such as this, it is possible to implement intuitive operation, by the user touching an operation actuator such as the index or middle finger or a touch pen to the display surface of the touch panel while holding the device.

When a user holds an electronic device, a finger might come into contact with a part of the touch panel. In order that the contacting by the finger is not detected as an operation input, an insensitive region is sometimes provided at the edge part of the touch panel or at the bottom part of the display surface. That is, even if the finger comes into contact with the insensitive region, an operation input is not accepted by the contacting, and an output signal is not generated from the touch panel.

In the operation information acquisition apparatus described in Patent Document 1, the operation type is acquired based on an output signal of a touch panel, the touched surface area of the touch panel is acquired, and a quantity corresponding to the acquired touched surface area is determined as an operation quantity of the acquired operation type. However, there is no language regarding an insensitive region of the touch panel, and no language regarding the effective use of touches to the edge part of the touch panel or the bottom part of the display surface.

### PRIOR ART DOCUMENT

### Patent Document

[Patent Document 1] Japanese Patent Application Publication No. 2012-164272

### SUMMARY OF THE INVENTION

### Problem to be Solved by the Invention

As described above, in the operation information acquisition apparatus described in Patent Document 1, because the operation type is not acquired based on an operation input by touching of the edge part of the touch panel or the bottom part of the display screen, it was not possible to improve the ease of operation by establishing an operation quantity responsive to the operation type. Also, the larger the insensitive region, the greater was the risk of not being able to effectively use the operation input.

The present invention is made in consideration of the above-noted points, and provides an electronic device, an information processing method, and an information processing program with an improved ease of operation responsive to the operation type.

### Means to Solve the Problem

One aspect of the present invention is made to solve the above-described problem, and one aspect of the present invention is an electronic device including: an operation input unit that accepts an operation input; an operation type determination unit that determines an operation type, the determination being made in accordance with a distribution of regions in which operation input is accepted in pre-established partial regions of the operation input unit; and an operation control unit that controls a processing according to an operation input, the control being made in response to an operation type determined by the operation type determination unit.

### Effect of the Invention

According to an embodiment of the present invention, it is possible to improve the ease of operation in response to the operation type.

### BRIEF DESCRIPTION OF THE DRAWINGS

FIG. 1 is as simplified block diagram showing the constitution of an electronic device according to a first embodiment of the present invention.

FIG. 2 is a plan view showing the electronic device according to the embodiment.

FIG. 3 is a conceptual drawing showing an example of the disposition of operation actuators contacting the touch panel.

FIG. 4 is a conceptual drawing showing an example of the distribution of the contact regions of operation actuators contacting the touch panel.

FIG. 5 is a conceptual drawing showing another example of the disposition of operation actuators contacting the touch panel.

FIG. 6 is a conceptual drawing showing another example of the distribution of the contact regions of operation actuators contacting the touch panel.

FIG. 7 is a flowchart showing an example of information processing according to the embodiment.

FIG. 8 is a flowchart showing another example of information processing according to the embodiment.

FIG. 9 is a simplified block diagram showing the constitution of an electronic device according to a second embodiment of the present invention.

FIG. 10 is a simplified block diagram showing the constitution of an electronic device according to a third embodiment of the present invention.

FIG. 11 is a plan view showing the electronic device of the embodiment.

### EMBODIMENTS FOR CARRYING OUT THE INVENTION

### First Embodiment

The first embodiment of the present invention will be described below, with references made to the drawings.

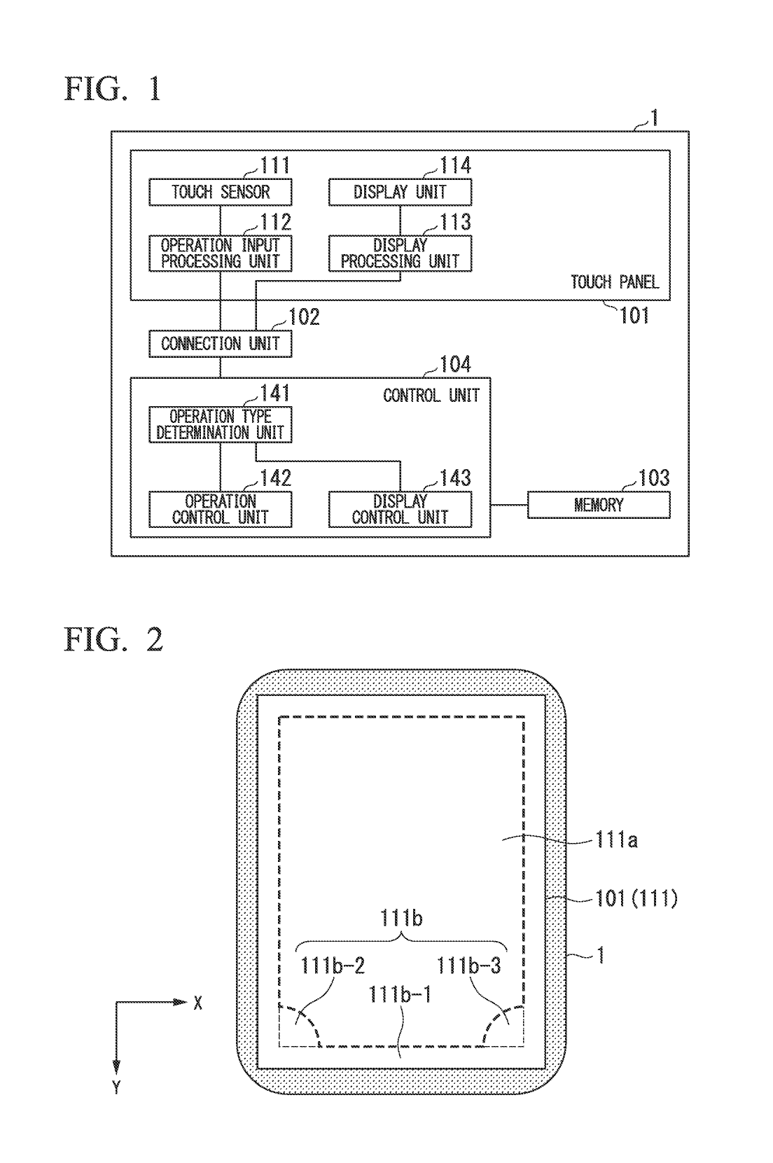

FIG. 1 is a simplified block diagram showing the constitution of an electronic device 1 according to the present embodiment.

The electronic device 1 is, for example, a multifunction mobile telephone handset (including a so-called smartphone), a tablet terminal device, or a personal computer. The electronic device 1 can be any size, as long as it can be carried by a user. The electronic device 1 has a size that approximately enables it to be held by a single human hand. In this case, the electronic device 1 has, for example, dimensional ranges of 55 to 85 mm in width, 100 to 160 mm in height, or 8 mm to 20 mm in thickness.

The electronic device 1 is constituted to include a touch panel 101, a connection unit 102, a memory 103, and a control unit 104.

The touch panel 101 is constituted to include a touch sensor (operation input unit) 111, an operation input processing unit 112, a display processing unit 113, and a display unit 114.

The touch sensor 111 detects the position of contact by an operation actuator (for example, a user finger) on the surface thereof, generates position information indicating the detected position, and outputs the generated position information to the operation input processing unit 112. That is, the position information indicates the position at which the operation input by the user has been accepted. In order to detect the position of contact by the operation actuator, the touch sensor 111, has, for example, a plurality of elements (for example, capacitive sensors or pressure sensors) arranged in a matrix on one surface thereof, and detects whether or not an operation actuator has contacted each sensor. That is, the position information indicates the detected position of each element touched by an operation actuator. The surface of the touch sensor 111 is divided between a sensitive part 111a and a peripheral edge part 111b, which will be described later (FIG. 2).

The operation input processing unit 112 and the display processing unit 113 are constituted, for example, by control components such as a CPU (central processing unit). The functions of the operation input processing unit 112 and the display processing unit 113 are implemented by the CPU executing a control program.

The operation input processing unit 112 functions, for example, by executing a program such as a touch sensor driver or the like. The operation input processing unit 112 detects position information input from the touch sensor 111 every pre-established time interval (for example, 20 ms) and performs processing to remove noise from the detected position information. The contact region in which an operation actuator contacts the touch sensor 111 is generally broad and there are cases in which a plurality thereof exist. For example, there are cases in which contact is made by a plurality of the user's fingers, in which contact is made by the fingertip and body of a one finger, and in which contact is made by a finger and the palm. Given this, the operation input processing unit 112 distinguishes each of the contact regions and calculates the surface area and operation point (for example, the center point) of each contact region. The calculated operation points are representative of the positions at which operation inputs are accepted when the operation actuator makes contact.

In order to distinguish between each contact regions, the operation input processing unit 112, for example, judges as a contact region a contiguous region occupied by a group of mutually neighboring elements that are touch sensor 111 elements that have detected touching by an operation actuator. The operation input processing unit 112 generates contact information (touch information) indicating the operation point and the surface area for each contact region and outputs the generated contact information via the connection unit 102 to the control unit 104. Contact regions indicated by the contact information are not restricted to the sensitive part 111a, and include as well contact regions belonging to the peripheral edge part 111b.

The display processing unit 113 has, for example, a function of executing a program such as a plotting driver. The display processing unit 113 outputs image information input from the control unit 104 to the display unit 114.

The front surface of a display panel of the display unit 114 makes contact with the rear surface of the panel of the touch sensor 111. The display unit 114 displays an image based on an image signal input from the display processing unit 113. The display unit 114 is, for example, a liquid display panel or an organic EL (electroluminescence) display panel. The display unit 114 may be, as shown in FIG. 1, integrated with the touch sensor 111, or may be a separate unit.

The connection unit 102 electrically connects between the touch panel 101 and the control unit 104 and transmits and receives signals therebetween.

The memory 103 stores a program (for example, an OS (operating system)) and application software (hereinafter, “an application”) executed by the control unit 104. The memory 103 also stores data used in processing by the control unit 104 and data generated by that processing. The memory 103 is, for example, a ROM (read-only memory) or a RAM (random-access memory).

The control unit 104 controls the operation of the electronic device 1. The control unit 104 is constituted to include, for example, a control component such a CPU and can implement various functions of electronic device 1 by executing a program stored in the memory 103. Considering the aspects of these functions, the control unit 104 is constituted to include an operation type determination unit 141, an operation control unit 142, and a display control unit 143.

The control unit 104, for example, might read an image signal regarding screen parts such as icons from the memory 103, output the read-out image signal to the display processing unit 113, and cause display of the screen parts at pre-established positions on the display unit 114. A screen part is an image indicating that a pointing device such as the touch sensor 111 can accept an operation input to the display region displayed on the display unit 114. The screen parts include, for example, icons, buttons, and links, which are referred to as UI (user interface) parts or GUI (graphic user interface) components.

The control unit 104 performs processing so that the electronic device 1 performs functions based on the relationship between the position of the operation point indicated by the contact information input from the operation input processing unit 112 and the position of the screen part displayed on the display unit 114. In the following description, this processing will be referred to as the operation function processing.

If the operation point indicated by the contact information input from the operation input processing unit 112 is included in a region displayed on a screen part (if the screen part is pressed), the control unit 104, for example, might execute a function responsive to that screen part. The function responsive to the screen part might be, for example, the launching of an application corresponding to the screen part or display an image based on the screen signal.

Depending upon the program being executed, the control unit 104 might scroll the screen when a flick operation is detected in an image displayed on the display unit 114. A flick operation is an operation whereby the operation point is moved while continuing to press a region in which an image is displayed on the touch panel 101. That is, the control unit 104 detects a flick operation if the operation point indicated by the contact information continues and moves. Scrolling of an image is the movement of the position at which an image is displayed in the direction of movement of the operation point.

The operation type determination unit 141 determines the operation type (operation mode) based on the contact information input from the operation input processing unit 112. The operation type determination unit 141 determines as the operation type, for example, whether the electronic device 1 is being held by the left or right hand, and whether it is being held by one hand (single-hand operation) or by both hands (two-hand operation). The operation type determination unit 141 generates operation type information indicating the determined operation type and outputs the generated operation type information to the operation control unit 142 and the display control unit 143. In this determination, the distribution of contact regions belonging to the peripheral edge part 111b (FIG. 2) of the contact regions indicated by the contact information is used. An example of the processing by the operation type determination unit 141 to determine the operation type will be described later.

The operation control unit 142, based on the operation type information input from the operation type determination unit 141, controls a change amount (movement amount) of the position of an image to be displayed on the display unit 114. For example, as a change amount for the case in which the input operation type information indicates single-hand operation, the operation control unit 142 establishes the scrolling amount larger than the scrolling amount for the case of two-hand operation. The scrolling amount is the proportion of the amount of change of the display position of an image with respect to the amount of change of the operation point indicated by the contact information. For a given amount of change of the operating point, the larger is the scrolling amount, the larger is the change amount of the position of the image to be displayed.

The scrolling amount for two-hand operation is indicated and the scrolling amount for single-hand operation is indicated are stored into the memory 103 beforehand. As the scrolling amount for the case of single-hand operation, a value larger, for example two times larger, than the scrolling amount for the case of two-hand operation is established. The operation control unit 142 then reads out the scrolling amount from the memory 103 in accordance with the input operation type information. The operation control unit 142 uses the read-out scrolling amount when controlling the position for display of an image in response to a scroll operation. This enables smooth operation even for single-hand operation, in which the movement of the fingers tends to be limited.

The display control unit 143, based on the operation type information input from the operation type determination unit 141, controls the form of displaying an image to be displayed on the display unit 114. The display control unit 143, based on the operation type information input from the operation type determination unit 141, controls the form of displaying an image to be displayed on the display unit 114. For example, if the input operation type information indicates that the electronic device 1 is being hand by one hand (for example, the left hand), the display control unit 143 may display screen parts with a distribution skewed to one side thereof (for example, the left side). More specifically, if the operation type information indicates that the electronic device 1 is being held by the left hand, screen parts are skewed further to the left than a pre-established distance (for example the center line in the left-right direction) from the left edge of the display unit 114. Because this distributes the screen parts in positions easy to reach by (close to) the single holding hand (for example, the left hand), the ease of operation of operation is improved when operating with a single hand.

The display control unit 143 may perform processing so as to skew the distribution in only the case in which the operation type information indicates single-hand operation (left-hand operation or right-hand operation). Also, regardless of whether an image to be displayed on the display unit 114 is a screen part, if the input operation type information indicates two-hand operation, the image may be displayed skewed toward the side opposite (for example, the right side) from the hand holding the electronic device 1 (for example the left hand). Because the hand used for operation does not cover the image to be displayed or operated, this enables maintenance of the visibility and ease of operation of the image.

An image to be displayed on the display unit 114 differs from a screen part in that it is a normal image that does not accept an operation input, and when the input operation type information indicates single-hand operation, images may be displayed so that screen parts are skewed toward the side opposite from that single hand. In this case, because the hand does not cover the displayed image, it is possible to maintain the visibility of the image.

Next, the various regions of the touch panel 101 according to the present embodiment will be described.

FIG. 2 is a plan view showing the electronic device 1 according to the present embodiment.

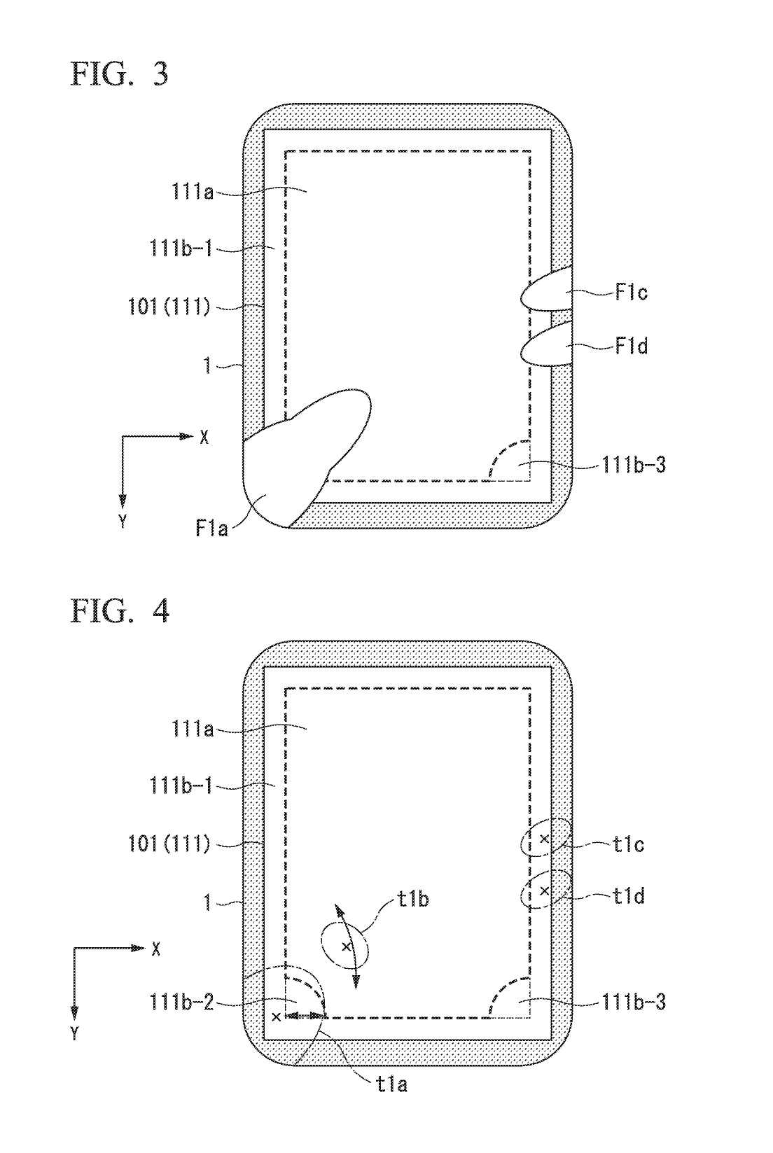

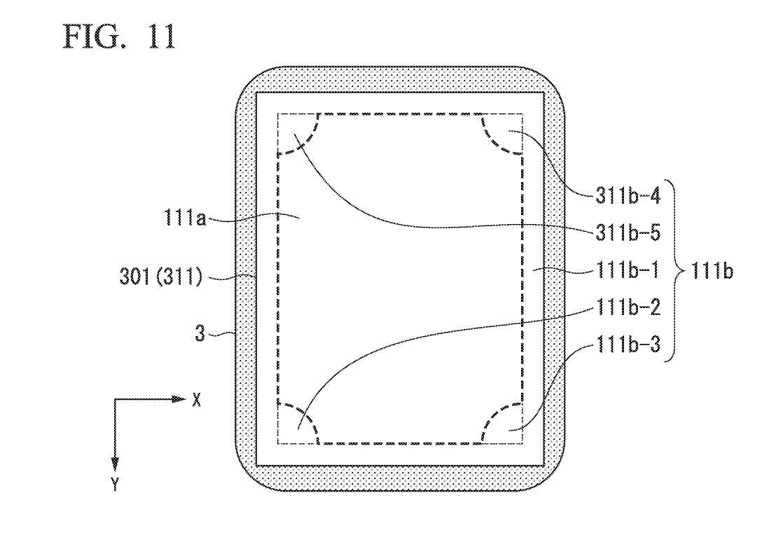

In the example shown in FIG. 2, the electronic device 1 has a portrait-format rectangular shape with the length of one side (the height) being greater than the length of another side (the width). In the present embodiment, this is not a restriction, and the electronic device 1 may have a landscape-format rectangular shape with a width that is greater than the height. In FIG. 2, the X direction indicates the width direction of the electronic device 1, and the Y direction indicates the height direction thereof. The X and Y directions shown in FIG. 2 are indicated the same way in FIG. 3 to FIG. 6 and in FIG. 11. In the description to follow, the X direction and Y direction are sometimes referred to as right and down.

The touch panel 101 covers the major portion of the surface of the electronic device 1. The region of the surface of the touch sensor 111 of the touch panel 101 contacted by an operation actuator is judged by the operation input processing unit 112 (FIG. 1) to be a contact region. The region to the inside of the thick broken line in the touch sensor 111 indicates the sensitive part 111a. The operation point calculated based on a contact region included in the sensitive part 111a is used in the operation function processing in the control unit 104 (FIG. 1), that is, in processing in response to an operation input by a user.

In the touch sensor 111, the region further to the outside of the thick broken line indicates the peripheral edge part 111b. Although the peripheral edge part 111b conventionally has been set to be an insensitive region, in the present embodiment, rather than being made an insensitive region, a contact region included in that region is also used. The peripheral edge part 111b is constituted by a side edge part 111b-1, a lower-left edge part 111b-2, and a lower-right edge part 111b-3.

The side edge part 111b-1 is a region having a prescribed width (for example, 6 mm) toward the inside from the right, top, left, and bottom sides of the outer periphery of the touch sensor 111. The lower-left edge part 111b-2 encroaches with a prescribed radius (for example 10 mm) toward the inside from vertex at the lower-left edge of the side edge part 111b-1, and is a fan-shaped region sandwiched between the side edge part 111b-1 and the sensitive part 111a. The lower-right edge part 111b-3 encroaches with a prescribed radius (for example 10 mm) toward the inside from vertex at the lower-right edge of the side edge part 111b-1, and is a fan-shaped region sandwiched between the side edge part 111b-1 and the sensitive part 111a.

In the description to follow, the lower-left edge part 111b-2 and the lower-right edge part 111b-3 will be collectively called the vertex edge parts.

Next, another example of an operation type determined by the operation type determination unit 141 (FIG. 1) according to the present embodiment will be presented. FIG. 3 is a conceptual drawing showing an example of the disposition of operation actuators contacting the touch sensor 101.

FIG. 3 shows the condition in which the user makes an operation with the tip part of the thumb F1a of the left hand while holding the electronic device 1 with the left hand. In this example, the body part of the thumb F1a, the tip part of the index finger F1c, and the tip part F1d of the middle finger of the left hand make contact, respectively, with the lower-left edge, the right-center, and slightly below the right center of the electronic device 1.

FIG. 4 is a conceptual drawing showing an example of the distribution of the regions of contact by operation actuators contacting the touch panel 101.

The example of FIG. 4 shows the contact regions obtained when treated as indicated in the example shown in FIG. 3. The two locations at the lower-left and the two locations at the right side of the touch panel 101 surrounded by single-dot-dashed lines are the contact regions t1a, t1b, t1c and t1d. The x symbols included in each of these contact regions indicate the operation points. The contact regions t1a, t1b, t1c, and t1d are the regions in which the body of the thumb F1a, the tip part of the thumb F1a, the tip part of the index finger F1c, and the tip part of the middle finger F1d, respectively, make contact with the touch panel 101. Because the operation point of the contact region t1b is included in the sensitive part 111a, it is used in the operation function processing performed by the control unit 104. Because the operation points of the contact regions t1a, t1c, and t1d are not included in the sensitive part 111a, they need not be used in the operation function processing performed by the control unit 104.

Although the contact region t1 a overlaps with the lower-left edge part 111b-2, no contact region overlaps with the lower-right edge part 111b-3. This is because, when the user holds the electronic device 1 with the left hand the body of the thumb F1a of the left hand mainly contacts the lower-left edge part 111b-2 and the fingers of the left hand do not contact the lower-right edge part 111b-3. Also, if the user holds the electronic device 1 with the right hand, the body of the thumb of the right hand contacts mainly the lower-right edge part 111b-3 and the fingers of the right hand do not contact the lower-left edge part 111b-2.

Given the above, if the surface area of the contact region included within the lower-left edge part 111b-2 is greater than the surface area of the contact region included within the lower-right edge part 111b-3, the operation type determination unit 141 determines that the electronic device 1 is being held by the left hand. In contrast, if the operation type determination unit 141 detects that the contact region included with the lower-right edge part 111b-3 and the detected contact region surface area is larger than the surface area of the contact region included within the lower-left edge part 111b-2, it determines that the electronic device 1 is being held by the right hand.

If the surface area of a contact region included within the lower-left edge part 111b-2 or lower-right edge part 111b-3 being compared is larger than a pre-established contact region surface area threshold, for example larger than 0.2 times the surface area of the lower-left edge part 111b-2, the operation type determination unit 141 may determine which of the left and right hands is holding the electronic device 1. If a part of an object other than an operation actuator is making contact with the lower-left edge part 111b-2 or the lower-right edge part 111b-3, this avoids making a misjudgment regarding which hand is doing the holding.

In FIG. 4, the arrows shown in the vicinities of each of the operation points of the contact regions t1a and t1b are the centers of the respective operation points, and indicate that the contact regions t1a and t1b move up and down and move left and right. This movement occurs because, when the tip part of the thumb F1a of one hand (for example, the left hand) moves in an operation, the body of the thumb F1a moves in concert therewith.

Given the above, if there is significant correlation between the operation point related to the contact region t1a occupying part or all of the lower-left edge part 111b-2 and the operation point related to the contact region t1b included in the sensitive part 111a, the operation type determination unit 141 determines that an operation has been made by the left hand that holds the electronic device 1. If the cross-correlation between the coordinates of the operation point related to the contact region t1 a and the coordinates of the operation point related to the contact region t1b included in the sensitive part 111a is larger than a pre-established cross-correlation threshold (for example, 0.1), the operation type determination unit 141 determines that there is a significant correlation.

In contrast, if there is significant correlation between the operation point related to the contact region occupying part or all of the lower-right edge part 111b-3 and the operation point related to the contact region included in the sensitive part 111a, the operation type determination unit 141 determines that an operation has been made by the right hand holding the electronic device 1.

Both operation by the right hand and operation by the left hand determined as noted above are types of single-hand operation.

If there is no significant correlation between an operation point related to a contact region occupying part or all of the lower-left edge part 111b-2 or the lower-right edge part 111b-3 and an operation point related to a contact region included in the sensitive part 111a, the operation type determination unit 141 determines that the electronic device 1 is operated by both hands.

That is, the determination is made that the hand on the opposite side (for example, the right hand) from the hand holding the electronic device 1 (for example, the left hand) is making an operation.

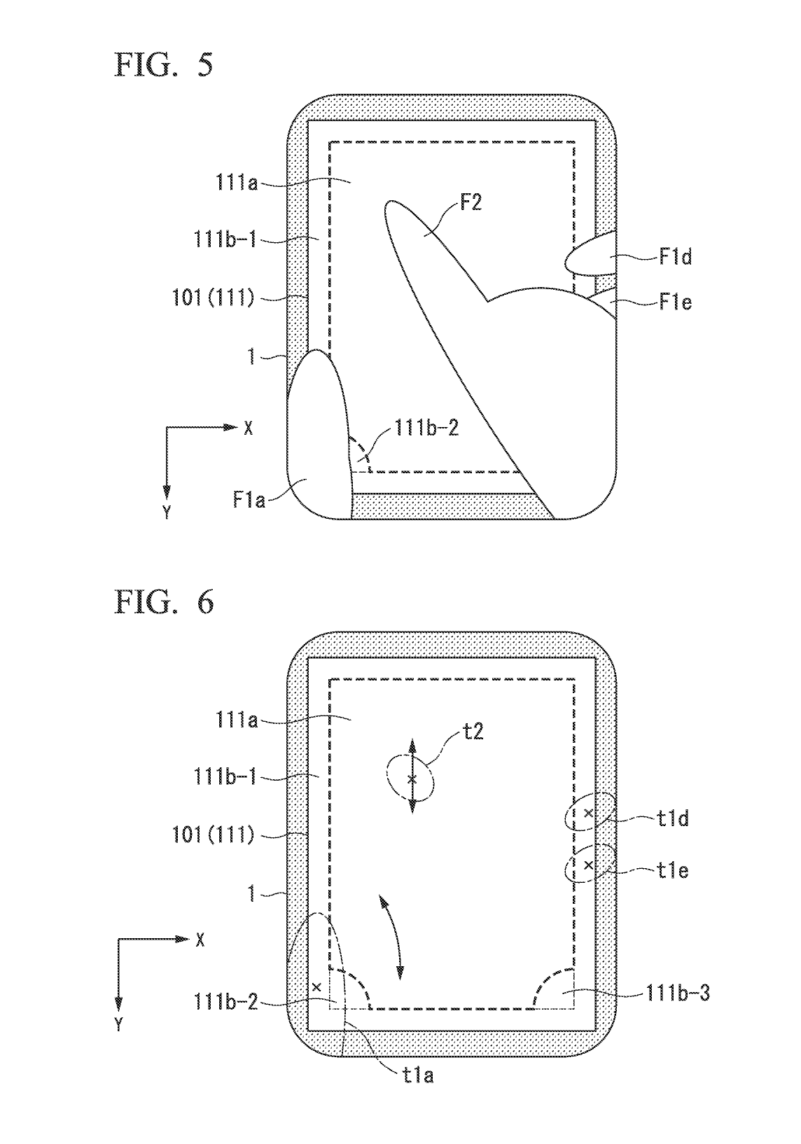

FIG. 5 is a conceptual drawing another example of the disposition of operation actuators contacting the touch panel 101.

FIG. 5 shows the condition in which the user makes an operation with the tip part of the index finger F2 of the right hand while holding the electronic device with the left hand. In this example, the body part of the thumb F1a, the tip part of the middle finger F1d, and the tip part of the ring finger F1e of the left hand make contact, respectively, with the lower-left edge, slightly above the right-center, and the right-center of the electronic device 1.

FIG. 6 is a conceptual drawing showing another example of the distribution of the regions of contact by operation actuators contacting the touch panel 101.

The contact regions t1e and t2 are the contact regions on the touch panel 101 contacted by the tip part of the ring finger F1e of the left hand and the tip part of the index finger F2 of the right hand. The two arrows shown in the vicinity of the operation point of the contact region t2 indicate, respectively, upward and downward movement. In contrast, the fact that these arrows are not shown in FIG. 3 in the vicinity of the operation point related to the contact region t1a indicates that the contact region t1a is substantially stationary. This means that, regardless of the movement of the contact region of the hand making an operation (for example, the right hand), the contact region of the hand holding the electronic device 1 (for example, the left hand) is substantially stationary.

When this is done, the operation type determination unit 141 determines that there is no significant correlation between the operation point t1a of a contact region occupying part or all of the lower-left edge part 111b-2 and the operation point related to the contact region t2 included in the sensitive part 111a. The operation type determination unit 141 therefore determines that the hand not holding the electronic device 1 (for example, the right hand) is making an operation and that two hands are operating the electronic device 1.

Next, an example of the information processing according to the present embodiment will be described.

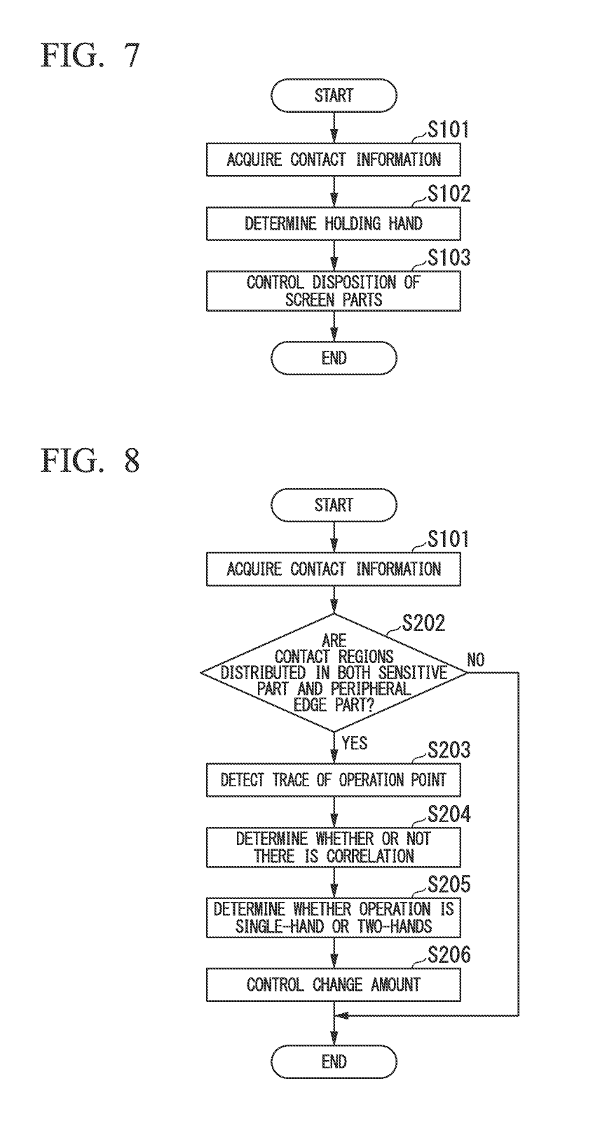

FIG. 7 is a flowchart showing an example of the information processing according to the present embodiment.

(Step S101) The operation input processing unit 112 detects position information input from the touch sensor 111 every pre-established time interval, distinguishes the contact regions indicated by the detected position information, and calculates the operation points of the contact regions, thus acquiring contact information related to the contact regions of the touch sensor 111 contacted by operation actuators. After that, processing proceeds to step S102.

(Step S102) The operation type determination unit 141 compares the surface area of a contact region included in the lower-left edge part 111b-2 with the surface area of a contact region included in the lower-right edge part 111b-3 and determines whether it is the left hand or the right hand that is holding the electronic device 1. From the standpoint of operation rather than that of holding, the operation type determination unit 141 may determine whether operation is by a single hand or two hands (refer to step S205 in FIG. 8). After that, processing proceeds to step S103.

(Step S103) The display control unit 143 controls the disposition of screen parts so that they skew toward the side of the hand (for example, the left hand) holding the electronic device 1. When a determination is made that single-hand operation is being done, the display control unit 143 may display images other than screen parts so that they are skewed toward the side (for example, the right side) opposite the hand holding the electronic device 1 (for example, the left hand). When a determination is made that two-hand operation is being done, the display control unit 143 may display images so that they are skewed toward the side (for example, the right side) opposite the hand holding the electronic device 1 (for example, the left hand). After that, the processing of this flowchart ends.

Next, another example of the information processing according to the present embodiment will be described.

FIG. 8 is a flowchart showing another example of the information processing according to the present embodiment.

The information processing of FIG. 8 includes step S101 (FIG. 7). Because the processing of step S101 is the same as that of step S101 in FIG. 7, the description thereof will be omitted. After execution of step S101, processing proceeds to step S202.

(Step S202) The operation type determination unit 141 determines whether or not contact regions having an operation point in the sensitive part 111a and an operation point occupying part or all of a vertex edge part (lower-left edge part 111b-2 or lower-right edge part 111b-3) are distributed on the touch panel 101. If both are distributed (YES at step S202), processing proceeds to step S203. If they are not distributed (NO at step S202), the processing of this flowchart ends.

(Step S203) The operation type determination unit 141 detects the trace of the operation point included in the sensitive part 111a and the trace of the operation point included in a contact region occupying part or all of the peripheral edge part 111b every pre-established time interval (for example, 3 seconds). After that, processing proceeds to step S204.

(Step S204) The operation type determination unit 141 calculates the cross-correlation between the trace of the operation point included in the sensitive part 111a and the trace of the operation point included in a contact region t1a occupying part or all of the peripheral edge part 111b. The operation type determination unit 141 determines whether or not there is a significant correlation between the two, by whether or not the calculated cross-correlation is greater than a pre-established threshold. After that, processing proceeds to step S205.

(Step S205) If it determines that there is a significant correlation between the two, the operation type determination unit 141 determines that single-hand operation is being done of the electronic device 1, and if it determines that there is no significant correlation between the two, the operation type determination unit 141 determines that the electronic device 1 is being operated by two hands. After that, processing proceeds to step S206.

(Step S206) The operation control unit 142 sets a scrolling amount (change amount) in accordance with whether the electronic device 1 is being operated by a single hand or both hands. The set scrolling amount is greater for single-hand operation than it is for two-hand operation. After that, the processing of this flowchart ends.

In the present embodiment, the electronic device 1 may execute the processing shown in FIG. 7 and the processing shown in FIG. 8 separately or in parallel.

As described above, in the present embodiment, the operation type is determined in accordance with the distribution of regions (for example contact regions) in which operation inputs are accepted in pre-established partial regions (for example, the peripheral edge part 111b) of an operation input unit (for example, a touch sensor 111) that accepts operation inputs, and processing related to the operation input is controlled in accordance with the determined operation type. In addition to utilizing operation input accepted in those partial regions not conventionally used to determine the operation type, processing in accordance with the determined operation type improves the ease of operation.

### Second Embodiment

Next, the second embodiment of the present invention will be described. Constituent elements that are the same as in the above-described embodiment are assigned the same reference numerals, and the descriptions thereof will be adopted.

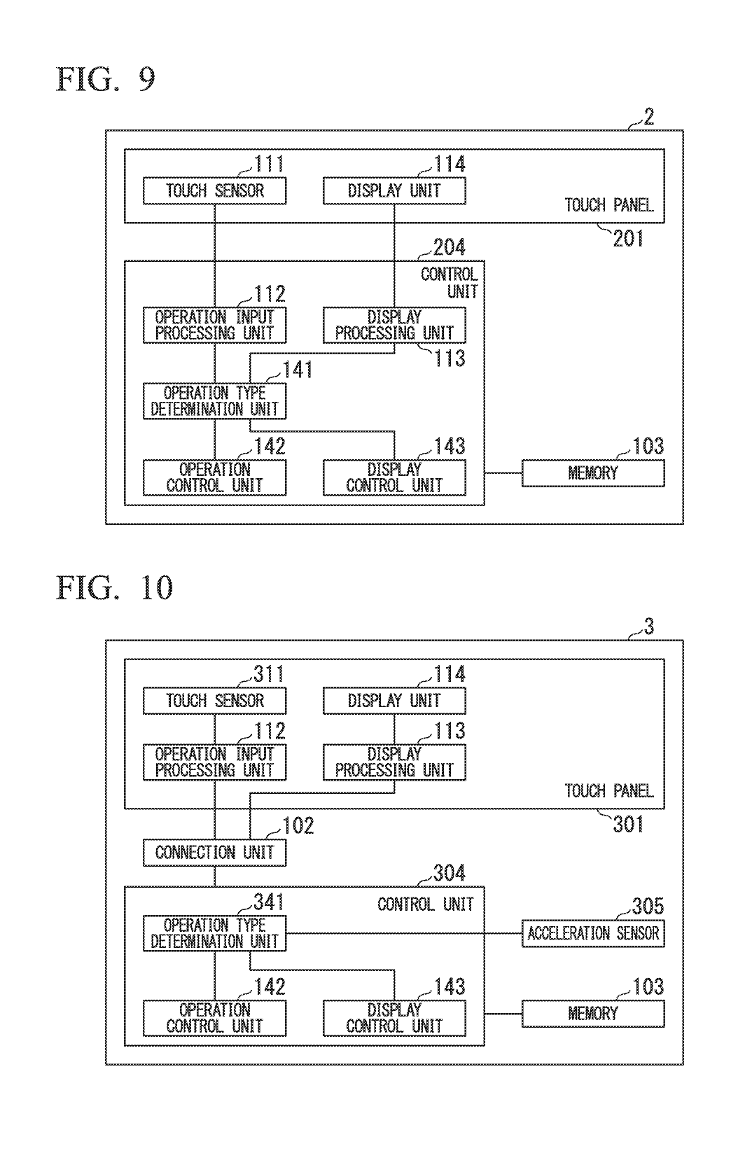

FIG. 9 is a simplified block diagram showing the constitution of an electronic device 2 according to the present embodiment.

In the electronic device 2 according to the present embodiment, a control unit 204, in addition to having the operation type determination unit 141, the operation control unit 142, and the display control unit 143, has the operation input processing unit 112 and the display processing unit 113. A touch panel 201 has the touch sensor 111 and the display unit 114. In the touch panel 201, however, the operation input processing unit 112 and display processing unit 113 of the first embodiment in FIG. 1 are omitted. Also, in the second embodiment (FIG. 9), the connection unit 102 (FIG. 1) of the first embodiment shown in FIG. 1 is omitted, and outputting of position information from the touch sensor 111 to the operation input processing unit 112 and in the second embodiment (FIG. 9) outputting of the image signal from the display processing unit 113 to the display unit 114 is made directly.

In the present embodiment, in addition to the operating effect of the above-described embodiment, by integrating the operation input processing unit 112 and the display processing unit 113 in the control unit 204, the operation type determination unit 141, the operation control unit 142, the display control unit 143, the operation input processing unit 112, and the display control unit 113 can operate by a common program (for example, an operating system) as a means to achieve high-speed processing. Additionally, components such as the CPU in the operation input unit (for example, the touch panel 201) and parts of the connection unit 102 and the like can be eliminated, thereby reducing the parts count.

### Third Embodiment

Next, the third embodiment of the present invention will be described. Constituent elements that are the same as in the above-described embodiments are assigned the same reference numerals, and the descriptions thereof will be adopted.

FIG. 10 is a simplified block diagram showing the constitution of an electronic device 3 according to the present embodiment.

The electronic device 3 according to the present embodiment has a touch panel 301 and a control unit 304 instead of the touch panel 101 and the control unit 104 in the electronic device 1 in FIG. 1 of the first embodiment, and further has an acceleration sensor 305.

The touch panel 301 has a touch sensor 311 instead of the touch sensor 111 in the touch panel 101 (FIG. 1). The control unit 304 has the operation type determination unit 341 instead of the operation type determination unit 141 in the control unit 104 (FIG. 1).

FIG. 11 is a plan view showing the electronic device 3 according to the present embodiment.

The touch sensor 311 has the sensitive part 111a and the peripheral edge part 111b the same as in the touch sensor 111 (FIG. 2). The peripheral edge part 111b has the side edge part 111b-1 and further a lower-left edge part 111b-2, a lower-right edge part 111b-3, an upper-right edge part 311b-4 upper-left edge part 311b-5 as four vertex edge parts. The upper-right edge part 311b-4 encroaches with a prescribed radius (for example 10 mm) toward the inside from vertex at the upper-right edge of the side edge part 111b-1 and is a fan-shaped region sandwiched between the side edge part 111b-1 and the sensitive part 111a. The upper-left edge part 311b-5 encroaches with a prescribed radius (for example 10 mm) toward the inside from vertex at the upper-left edge of the side edge part 111b-1 and is a fan-shaped region sandwiched between the side edge part 111b-1 and the sensitive part 111a.

Returning to FIG. 10, the acceleration sensor 305 detects the gravitational acceleration and outputs to the operation type determination unit 341 an acceleration signal indicating the detected gravitational acceleration. The acceleration sensor 305 is a three-axis acceleration sensor having sensitive axes in three mutually orthogonal directions. In the electronic device 3, two sensitive axes of three sensitive axes of the acceleration sensor 305 are disposed in the X and Y directions respectively. This enables detection of the components of the gravitational acceleration at least in the X and Y directions, that is, the inclination within the X and Y planes of the electronic device 3.

The operation type determination unit 341 performs the same processing as the operation type determination unit 141 (FIG. 1). The operation type determination unit 341, however, determines which two of four vertex edge parts based on the acceleration signal input from the acceleration sensor 305 are to be used in the operation function processing in accordance with the sensitive part 111a or remaining two are used to determine the operation type in accordance with the above-described peripheral edge part 111b. In this case, the operation type determination unit 341 determines that the two vertex edge parts set to both edges of the bottom side of the touch sensor 311 are to be used to determine the operation type, and that the remaining two vertex edge parts are to be used in the operation function processing.

Specifically, when the value of the Y component of the acceleration signal is greater positive value than the value of the X component, the operation type determination unit 341 determines that the lower side of the touch sensor 311 is taken as the bottom side and that the lower-left edge part 111b-2 and the lower-right edge part 111b-3 are to be used to determine the operation type.

The operation type determination unit 341 determines that, when the value of the X component of the acceleration signal is a positive value greater than the absolute value of the Y component, the right side of the touch sensor 311 is taken as the bottom side, and the lower-right edge part 111b-3 and the upper-right edge part 311b-4 are to be used to determine the operation type.

When the absolute value of the Y component of the acceleration signal is greater than the absolute value of the X component and the value of the Y component is the negative value, the operation type determination unit 341 determines that, the upper side of the touch sensor 311 is taken as the bottom side and that the upper-right edge part 311b-4 and the upper-left edge part 311b-5 are to be used to determine the operation type.

When the absolute value of the X component of the acceleration signal is greater than the absolute value of the Y component and the value of the X component is the negative value the operation type determination unit 341 determines that, the left side of the touch sensor 311 is taken as the bottom side and the upper-left edge part 311b-5 and the lower-left edge part 111b-2 are to be used to determine the operation type.

The electronic device 3 according to the present embodiment may have the touch sensor 311 and the operation type determination unit 341 instead of the touch sensor 111 and the operation type determination unit 141 of the electronic device 2 (FIG. 9) and may further have the acceleration sensor 305.

As described above, the present embodiment determines whether or not the pre-established regions from each vertex of the operation input unit (for example, the touch sensor 311) in accordance with the detected gravitational acceleration are to be used to determine the operation type in accordance with the distribution of regions (for example contact regions) in which operation inputs are accepted. This enables accurate determination of the operation type regardless of the direction (for example, holding in the vertical or horizontal direction) in which a user holds the electronic device (for example, electronic device 3) according to the present embodiment.

Additionally, the above-described embodiment can be executed in the in the following embodiments.
(1) An electronic device having an operation input unit that accepts operation input, an operation type determination unit that determines the operation type in accordance with the distribution of regions in which operation input are accepted in pre-established partial regions of the operation input unit, and an operation control unit that controls processing according to an operation input in response to the operation type determined by the operation type determination unit.
(2) The electronic device of (1), wherein the operation control unit controls a change amount of the position of an image to be displayed on a display unit in response to the operation type determined by the operation type determination unit.
(3) The electronic device of either (1) or (2) having a display control unit that controls the format of displaying an image on a display unit in response to the operation type determined by the operation type determination unit.
(4) An information processing method in an electronic device, the information processing method having a step of determining an operation type in accordance with the distribution of regions in which operation inputs are accepted in pre-established partial regions of an operation input unit that accepts an operation input, and a step of controlling operation according to an operation input in response to the operation type determined by the operation type determining step.
(5) An information processing program for causing a computer of an electronic device to execute a procedure of determining an operation type in accordance with the distribution of regions in which operation inputs are accepted in pre-established partial regions of an operation input unit that accepts an operation input, and a procedure of controlling operation according to an operation input in response to the operation type determined by the operation type determining step.

According to the above-described (1), (4) or (5), the operation inputs accepted by parts of region are utilized to determine the operation type so that it is possible to improve the ease of operation by processing in response to the determined operation type.

According to the above-described (2), it is possible to improve the ease of operation by controlling a change amount of the position of an image to be displayed in response to the determined operation type.

According to the above-described (3), it is possible to improve the ease of operation and the visibility by displaying the image in a form responsive to the determined operation type.

Parts of the electronic devices 1, 2 and 3 in the above-described embodiments, for example, the control units 104, 204 and 304, may be implemented by a computer. In this case, they may be implemented by recording a program for implementing the control functionality into a computer-readable recording medium and by having a computer system read and execute the program recorded in the recording medium. The term “computer system” used here means computer system incorporated into the electronic devices 1, 2 and 3, and includes an operating system and hardware such as peripheral devices. The term “computer-readable recording medium” refers to a removable medium such as a flexible disk, an optomagnetic disk, a ROM, a CD-ROM, or to a storage device such as a hard disk built into a computer system. Additionally, the term “computer-readable recording medium” may encompass one holding a program over a short time dynamically such as a communication line when a program is transmitted via a network such as the Internet or via a communication line such as a telephone line and one holding a program for a given period of time, such as a volatile memory within a computer system serving as a server or client. The above-noted program may be for implementing a part of the above-described functionality. Additionally, it may be one enabling implementation by combination with a program that already has recorded the above-noted functionality in a computer system.

A part or all of the electronic devices 1, 2 and 3 according to the above-described embodiments may implemented as an integrated circuit such as LSI (large-scale integration). Each of the functional blocks of the electronic devices 1, 2 and 3 may be implemented by a processor separately or a part or all thereof may be implemented in integrated fashion as a processor. The method of integrated circuit implementation is not restricted to LSI, and implementation may be done by dedicated circuitry or a general-purpose processor. Additionally, in the event of the appearance of integrated circuit implementation taking the place of large-scale integration by advances in semiconductor technology, an integrated circuit using that technology may be used.

Although the foregoing has been a detail description of embodiments of the present invention, with references to the drawings, the specific constitution is not limited to the above, and may include various design modifications, within the scope of the spirit of the invention.

### INDUSTRIAL APPLICABILITY

The present invention can be applied to an electronic device, an information processing method and an information processing program requiring improved ease of operation in response to the operation type.

### DESCRIPTION OF REFERENCE NUMERALS

1, 2, 3 Electronic device
101, 201, 301 Touch panel
102 Connection unit
103 Memory
104, 204, 304 Control unit
305 Acceleration sensor
111, 311 Touch sensor
112 Operation input processing unit
113 Display processing unit
114 Display unit
141, 341 Operation type determination unit
142 Operation control unit
143 Display control unit

1-5. (canceled)

6. An electronic device comprising:
an operation input unit configured to accept an operation input;
an operation type determination unit configured to determine an operation type, the determination being made in accordance with a distribution of regions in which the operation input is accepted in pre-established partial regions of the operation input unit; and
an operation control unit configured to control a processing according to the operation input, the control being made in response to the operation type determined by the operation type determination unit.

7. The electronic device according to claim 6,
wherein the operation control unit is configured to control a change amount of a position of an image to be displayed on a display unit, the control of the change amount being made in response to the operation type determined by the operation type determination unit.

8. The electronic device according to claim 6, the electronic device further comprising:
a display control unit configured to control a format of displaying the image on the display unit, the control of the format being made in response to the operation type determined by the operation type determination unit.

9. An information processing method in an electronic device, the information processing method comprising:
determining an operation type, the determination being made in accordance with a distribution of regions in which an operation input is accepted in pre-established partial regions of an operation input unit that accepts the operation input; and
controlling a processing according to the operation input, the control being made in response to the determined operation type.

10. A non-transitory computer readable recording medium storing an information processing program for causing a computer of an electronic device to execute:
determining an operation type, the determination being made in accordance with a distribution of regions in which an operation input is accepted in pre-established partial regions of an operation input unit that accepts the operation input; and
controlling a processing according to the operation input, the control being made in response to the determined operation type.
